(19) United States
(12) Patent Application Publication
(10) Pub. No.: US 2018/0020878 A1
(43) Pub. Date: Jan. 25, 2018

(54) Valve Control and Monitoring System for a Shower Head

(71) Applicants: Uwila Colburn, Henderson, NV (US); Kareen Colburn, Henderson, NV (US)

(72) Inventors: Uwila Colburn, Henderson, NV (US); Kareen Colburn, Henderson, NV (US)

(21) Appl. No.: 15/218,957

(22) Filed: Jul. 25, 2016

(51) Int. Cl. A47K 3/28; G01F 1/00; B05B 12/00; F16K 31/46; F16K 31/60

(52) U.S. Cl. CPC A47K 3/281; F16K 31/46; F16K 31/60; B05B 12/002; G01F 1/00

(57) ABSTRACT

A water control and monitoring system for a shower head comprising a water flow meter, and a water control valve and a valve adjustment rod couple to the control valve on one end and a grip retention handle on the other end. The water flow meter is coupled in-line with a pipe passing through a shower wall to a shower head. The water control valve is coupled with the pipe passing through the shower wall to the shower head. The valve control rod extends down from the control valve greater than a foot to the rubber grip retention handle and is adapted to control the position of the water control valve. The grip retention handle forms a cavity that allows a user to insert their hand and applies enough force to the hand that the user can adjust water pressure simply by twisting their wrist. The water control and monitoring system provides an effective way to monitor water consumption as well as allow for easy control of water pressure, which is useful for those small in stature and the elderly or otherwise disabled.

### TECHNICAL FIELD

The present invention relates generally to valve control and water monitoring systems and more particularly to water saving shower heads.

### BACKGROUND

Considering the environmental challenges the world faces, water conservation is a practical consideration most people follow in their day to day water use and in some places where water resources are scarce due to droughts, restrictions are mandated by state and local governments. A lot of shower heads and water faucets in use today operate dual functionally; i.e. if the water faucet is turned on, the water pressure and temperature are dependent on the valve restriction of the faucet. These types of water faucets are cheap to manufacture, but inherently waste water. For example, if a user using one of these types of shower heads and water faucets were to take a shower, in order to get suitable water temperature, the amount of water delivered would be determined by such temperature, since the valve restriction and, therefore, pressure determine the temperature. As such, most people using these types of faucets and shower heads tend to waste a lot of water.

In addition, there are a lot of people that prefer taking showers, as opposed to baths, and some of these people, e.g. children and the elderly, may have problems reaching for shower head or faucet controls to control the amount of temperature and pressure. Children simply may not be tall enough and the elderly may be incapable of doing so.

As such, there is a need for a shower head that can control the pressure without effecting the temperature and further provide users with an easier way to do so.

### SUMMARY

The present invention is directed to a control and monitoring system for a shower head.

According to this invention, the control and monitoring system comprises a water flow meter for recording the amount of water passing through the meter and is adapted to couple with a pipe passing through a shower wall to a shower head. This pipe is adapted to deliver water to the shower head. The control and monitoring system further comprises a water flow valve coupled with the pipe that passes through a shower wall to a shower head. The water flow valve including coupled thereto a water flow adjustment rod extending downward from the water flow valve to a handle that is adapted to control the position of the water flow valve.

According to this invention, the water flow adjustment rod coupled to the water flow valve extends downward from the shower arm to the handle. The rod extending downward to the handle is greater than one foot. The handle may also be made of rubber and may include an opening that allows a hand to be inserted in order to turn the rod.

### BRIEF DESCRIPTION OF THE DRAWINGS

FIG. 1 is a side view of a control and monitoring system for a shower head that includes water flow meter, control value, and flow adjustment rod with handle.

FIG. 2 is a side view and alternate embodiment of the handle.

FIG. 3 is a perspective view of the control and monitoring system for a shower head.

### DETAILED DESCRIPTION

The present invention is directed to a water pressure control and monitoring system usable with shower heads and water delivery systems for bathrooms where the shower head mounts to a wall in the bathroom through the water delivery system and provides an effective and user friendly way to control water usage.

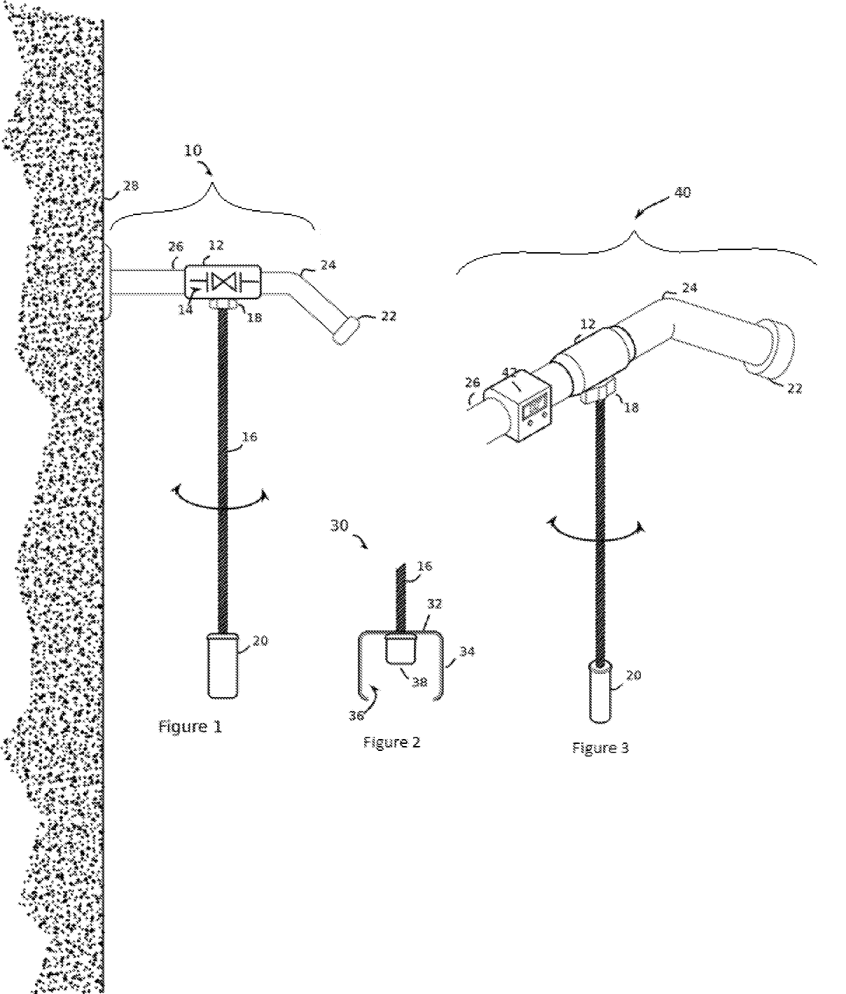

Referring to FIG. 1, a bathroom shower arm and mechanism 10 is illustrated that uses an embodiment of the aforementioned water pressure control and monitoring system. The bathroom shower arm and mechanism 10 includes a pipe fitting housing 12 with a valve 14 positioned therein and a water flow adjustment rod 16 coupled to the valve 14 through pipe fitting 18; the water flow adjustment rod 16 extends downward away from the housing 12 to a handle 20. The rod 16 should be of a length greater than a foot so as to allow someone sitting in a chair, e.g. an elderly person or a small child to be able to reach the handle. The rod 16 can be rotated 180 degrees about the axis of the rod in either direction to allow the opening and closing of the valve 14. Ideally, the handle 20 would be made of rubber so as to allow for an easier more secure grip during showering.

The pipe fitting housing 12 couples in-line to a shower head 22 through a first section of pipe 24 and to a second section of pipe 26 that is adapted to deliver water to the shower head 22. The second section of pipe 26 extends through a wall 28 to a water source and the amount of water pressure applied is controlled by the pipe fitting housing 12 with the valve 14 positioned therein and the water flow adjustment rod 16.

Referring now to FIG. 2, illustrated is a grip retention handle that can be used in addition to the handle illustrated in FIG. 1 to allow the rod 16 to be turned without actually using the handle 20. This may be useful for those with arthritis or for other reasons can't grip the handle 20.

The grip retention handle 30 includes a base top portion 32 and a side wall portion 34 surrounding and continuing the base top portion 32 to form a cavity 36. The grip retention handle 30 is secured in place by the bottom base of the rod and the top base of a stubbed handle 38. The grip retention handle 30 may be made of rubber so that a user's hand or fist, when inserted into the cavity, would result in the rubber applying enough force to the hand that when the user applied enough pressure by turning their hand the result would cause the rod to rotate in the user's desired direction.

Referring to FIG. 3, a bathroom shower arm and mechanism 40 is illustrated that uses the aforementioned water pressure control system of FIG. 1 and a water monitoring system for recording the amount of water used during a cycle.

The bathroom shower arm and mechanism 40 includes the pipe fitting housing 12 with the valve 14 positioned therein and a water flow adjustment rod 16 coupled to the valve 14 through pipe fitting 18; the water flow adjustment rod 16 extending downward from the housing 12 at least one foot to the handle 20. The rod can be rotated 180 degrees about the axis of the rod in either direction allowing the opening and closing of the valve. Ideally, the handle 20 would be made of rubber so as to allow for an easier and more secure grip during showering.

The pipe fitting housing 12 couples in-line to the shower head 22 through the first section of pipe 24 and to the second section of pipe 26 that is adapted to deliver water to the shower head 22. In this example embodiment, a water meter 42 is positioned in-line with the second section of pipe 26 to allow for recording of water consumption during a cycle. Although, the water meter 42 could be placed in-line with the first section 24 of pipe.

Thus, while the fundamental novel features of the invention have been shown, described, and pointed out in a preferred embodiment thereof, it will be understood that various omissions, substitutions, and changes in the form, details of the apparatus illustrated, and its operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A control and monitoring system for a shower head, comprising:
a water flow meter coupled in-line with a pipe passing through a shower wall to a shower head, said pipe being adapted to deliver water to a shower head;
a water flow valve coupled in-line with the pipe passing through the shower wall to the shower head, the water flow valve including coupled thereto a water flow adjustment rod extending downward from the water flow valve to a handle that is adapted to control the position of the water flow valve; and
wherein the water flow meter records the amount of water dispensed for the duration of the flow of water through the pipe.

2. The control system of claim 1 wherein the water flow adjustment rod coupled to the water flow valve extends downward from the shower arm to the handle is greater than one foot.

3. The control system of claim 1 wherein the handle is made of rubber.

4. The control system of claim 1 wherein the handle is a grip retention handle that includes a base top portion and an side wall portion surrounding and continuing the base top portion to form a cavity.

5. The control system of claim 4 wherein the grip retention handle is made of rubber.

6. A control system for a shower head, comprising:
a water flow valve coupled with the pipe passing through the shower wall to the shower head, the water flow valve including coupled thereto a water flow adjustment rod extending downward from the water flow valve to a handle that is adapted to control the position of the water flow valve;
the water flow adjustment rod coupled to the water flow valve extends downward from the shower arm to the handle and is greater than one foot; and
the handle is made of rubber.

7. The control system of claim 6 further comprising a water flow meter adapted to couple with a pipe passing through a shower wall to a shower head, said pipe being adapted to deliver water to a shower head;

8. The water flow meter of claim 7 wherein the water flow meter records the amount of water dispensed for the duration of the flow of water through the pipe.

9. The control system of claim 6 wherein the handle is a grip retention handle that includes a base top portion and an side wall portion surrounding and continuing the base top portion to form a cavity.
